(19) United States
(12) Patent Application Publication
(10) Pub. No.: US 2003/0124241 A1
(43) Pub. Date: Jul. 3, 2003

(54) Animal feed composition

(76) Inventor: Paul S. Westdal, Winnipeg (CA)

Correspondence Address: SIM & MCBURNEY, 330 UNIVERSITY AVENUE, 6TH FLOOR, TORONTO, ON, M5G 1R7, CA

(21) Appl. No.: 10/266,701

(22) Filed: Oct. 9, 2002

Related U.S. Application Data
(60) Provisional application No. 60/327,797, filed on Oct. 10, 2001.

(51) Int. Cl. A23K 1/165; A23K 1/17

(52) U.S. Cl. 426/635

(57) ABSTRACT

A canola protein isolate is used as at least partial replacement for proteinaceous material in animal feed compositions, particularly for domestic pets.

### REFERENCE TO RELATED APPLICATIONS

This application claims priority under 35 USC 119(e) from U.S. Provisional Application No. 60/327,797 filed Oct. 10, 2001.

### FIELD OF INVENTION

The present invention relates to animal food compositions, particularly those based on canola protein isolate.

### BACKGROUND TO THE INVENTION

in U.S. Pat. Nos. 5,844,086 and 6,005,076 (“Murray II”), assigned to the assignee hereof and the disclosures of which are incorporated herein by reference, there is described a process for the isolation of protein isolates from oil seed meal having a significant fat content, including canola oil seed meal having such content. The steps involved in this process include solubilizing proteinaceous material from oil seed meal, which also solubilizes fat in the meal and removing fat from the resulting aqueous protein solution. The aqueous protein solution may be separated from the residual oil seed meal before or after the fat removal step. The defatted protein solution then is concentrated to increase the protein concentration while maintaining the ionic strength substantially constant, after which the concentrated protein solution may be subjected to a further fat removal step. The concentrated protein solution then is diluted to cause the formation of a cloud-like mass of highly aggregated protein molecules as discrete protein droplets in micellar form. The protein micelles are allowed to settle to form an aggregated, coalesced, dense amorphous, sticky gluten-like protein isolate mass, termed “protein micellar mass” or PMM, which is separated from residual aqueous phase and dried.

The protein isolate has a protein content (as determined by Kjeldahl N×6.25) of at least about 90 wt %, is substantially undenatured (as determined by differential scanning calorimetry) and has a low residual fat content. As used herein, the term “protein content” is determined on a dry weight basis. The yield of protein isolate obtained using this procedure, in terms of the proportion of protein extracted from the oil seed meal which is recovered as dried protein isolate was generally less than 40%, typically around 20%.

The procedure described in the aforementioned patents was developed as a modification to and improvement on the procedure for forming a protein isolate from a variety of protein source materials, including oil seeds, as described in U.S. Pat. No. 4,208,323 (Murray IB). The oil seed meals available in 1980, when U.S. Pat. No. 4,208,323 issued, did not have the fat contamination levels of canola oil seed meals available at the time of U.S. Pat. Nos. 5,844,086 and 6,005,096, and, as a consequence, the procedure of U.S. Pat. No. 4,208,323 cannot produce from the current oil seed meals processed according to the Murray II process, proteinaceous materials which have more than 90 wt % protein content. There is no description of any specific experiments in U.S. Pat. No. 4,208,303 carried out using rapeseed (canola) meal as the starting material.

U.S. Pat. No. 4,208,323 itself was designed to be an improvement on the process described in U.S. Pat. Nos. 4,169,090 and 4,285,862 (Murray IA) by the introduction of the concentration step prior to dilution to form the PMM. The latter step served to improve the yield of protein isolate from around 20% for the Murray IA process.

In copending U.S. Patent Applications Nos. 60/288,415 filed May 4, 2001, 60/326,987 filed Oct. 5, 2001, 60/331,066 filed Nov. 8, 2001, 60/374,801 filed Apr. 29, 2002 and Ser. No. 10/137,301 filed May 3, 2002, all assigned to the assignee hereof and the disclosure of which are incorporated herein by reference, there is described further improvements on these prior art protein isolation procedures as they apply to oil seeds to obtain improved yields of dried isolated product protein in terms of the proportion of the protein extracted from the oil seeds which is recovered as protein isolate and to obtain protein isolates of protein content of at least about 100 wt % at a Kjeldahl nitrogen (N) conversion rate of N×6.25. This procedure is employed particularly to produce a canola protein isolate.

In the procedure described in the aforementioned U.S. patent applications, the oil seed meal is extracted with an aqueous food grade salt solution. The resulting protein extract solution, after an initial treatment with pigment adsorbing agent, if desired, is reduced in volume using ultrafiltration membranes to provide a concentrated protein solution having a protein content in excess of about 200 g/L. The concentrated protein solution then is diluted into chilled water having a temperature below about 15° C., resulting in the formation of a white cloud of protein micelles which are allowed to separate. Following removal of the supernatant, the precipitated, viscous sticky mass (PMM) is dried.

In one embodiment of the process described above and as specifically described in U.S. Patent Applications Nos. 60/326,987, 60/331,066, 60/333,494, 60/374,801 and Ser. No. 10/137,391, the supernatant from the PMM settling step is processed to recover a protein isolate comprising dried protein from wet PMM and supernatant. This procedure may be effected by initially concentrating the supernatant using ultrafiltration membranes, mixing the concentrated supernatant with the wet PMM and drying the mixture. The resulting canola protein isolate has a high purity of at least about 90 wt %, preferably at least about 100 wt %, protein (N×6.25).

In another embodiment of the process described above and as significantly specifically described in Applications Nos. 60/331,066, 60,333,494, 60/374,801 and Ser No. 10/137,391, the supernatant from the PMM settling step is processed to recover a protein from the supernatant. This procedure may be effected by initially concentrating the supernatant using ultrafiltration membranes and drying the concentrate. The resulting canola protein isolate has a high purity of at least about 90 wt %, preferably at least about 100 wt %, protein (N×6.25).

In copending U.S. Patent Applications No. 60/331,646 filed Nov. 20, 2001 and 60/383,809 filed May 30, 2002, assigned to the assignee hereof and the disclosure of which are incorporated herein by reference, there is described a continuous process for making canola protein isolates. In accordance therewith, canola oil seed meal is continuously mixed with a food grade salt solution, the mixture is conveyed through a pipe while extracting protein from the canola oil seed meal to fort an aqueous protein solution, the aqueous protein solution is continuously separated from residual canola oil seed meal, the aqueous protein solution is continuously conveyed through a selective membrane operation to increase the protein content of the aqueous protein solution to at least about 200 g/L while maintaining the ionic strength substantially constant, the resulting concentrated protein solution is continuously mixed with chilled water to cause the formation of protein micelles, and the protein micelles are continuously permitted to settle while the supernatant is continuously overflowed until the desired amount of protein micellar mass has accumulated in the settling vessel. The protein micellar mass is removed from the settling vessel and may be dried. The protein micellar mass has a protein content of at least about 100 wt % as determined by Kjeldahl nitrogen (N×6.25). As in the case of the aforementioned pending U.S. patent applications, the overflowed supernatant may be proceeded to recover a protein isolate comprising dried protein from the wet PMM and supernatant.

None of this prior art discloses or suggests that Canola protein isolates may be used in animal feed compositions without adversely affecting the effectiveness of the animal feed composition.

Canola is also termed rapeseed or oil seed rape.

### SUMMARY OF THE INVENTION

Animal reed compositions, such as for domestic pets, contain a variety of ingredients, including proteinaceous materials. It has been found in animal studies that a canola protein isolate produced according to the above-described procedures can be used as an at least partial replacement for the proteinaceous material used in animal food compositions without adversely affecting food composition, body weight gain and organ weight.

Accordingly, in one aspect of the present invention, there is provided, in an animal feed composition comprising at least one proteinaceous material, the improvement which comprises at least partially replacing the at least one proteinaceous material with at least one canola protein isolate having a protein content of at least about 90 wt % as determined by Kjeldahl nitrogen ×6.25 on a dry weight basis, preferably at least about 100 wt %. The animal feed composition is preferably formulated for domestic pets.

The canola protein isolate may be any one of those produced according to the prior art procedures, as described above Although a canola protein isolate may be derived following the procedures of the Murray IA and IB patents, there is no description of any specific experiments carried out using rapeseed (canola) oil seed meal as the starting material. As described in these Murray patents, the protein isolates were obtained to purity levels which did not exceed 100 wt % (N×6.25).

For canola oil seed meal contaminated with, fat, the procedure of Murray II may be applied thereto with defatting steps included to remove the contaminating fat.

The canola protein isolate may be produced by procedures of the above-mentioned copending applications, including a canola protein isolate in the form of a dried protein micellar mass and having a protein content of at least about 100 wt % (N×6.25). The canola protein isolate also may be that derived from supernatant from the precipitation of protein micellar mass and having a protein content of at least about 90 wt %, preferably at least about 100 wt %, (N×6.25), either alone or blended with PMM.

### BRIEF DESCRIPTION OF DRAWINGS

FIGS. 1 to 8 are graphical representative of results obtained in the feeding trial described in the Example.

### EXAMPLE

Canola protein isolate was evaluated in a standard animal feed composition (AIN-93G) as a replacement for the protein (casein) utilized therein. AIN-93G is the growth diet for rodents recommended by the American Institute of Nutrition. Samples of canola protein isolate for (CPI) use in his Example were prepared as described in the aforementioned U.S. Application No. 60/288,415. CPI samples, CPI I and CPI II, were evaluated at 25 and 50% replacement of the total protein in the diet. The components of the AIN-93G composition as set forth in Table II below.

50 21 to 28 days old Male Fischer 344 rats weighing about 50 grams each, were obtained from Charles River. Animals were maintained in individual cages with corn bedding and adlibetum access to food and water. Animals underwent a 6 day acclimatization period. Following the acclimatization period, the animals were randomized into 5 groups of 10 rats each as follows:

| | |
|---|---|
| Group I (control): | Receiving control diet (AIN-93G containing |
| | 200 g casein/kg diet). |
| Group II (CPI-I 25%): | Receiving CPI I 25% diet (AIN-93G containing |
| | 150 g/kg casein and 50 g/kg CPI I). |
| Group III (CPI-I 50%): | Receiving CPI I 50% diet (AIN-93G containing |
| | 100 g/kg casein and 100 g/kg CPI I). |
| Group IV (CPI-II 25%): | Receiving CPI II 25% diet (AIN-93G |
| | containing 150 g/kg casein and 50 g/kg (CPI |
| | II). |
| Group V (CPI-II 50%): | Receiving CPI II 50% diet (AIN-93G |
| | containing 100 g/kg casein and 100 g/kg CPI |
| | II). |

Body weight and the food intake data was collected every 3 to 4 days for 28 days and on the 29^{th} day the animals were sacrificed and major organs (liver, heart, kidney, spleen and testes) were weighed.

The following calculations were made:

1. Food intake and Body weights were measured every 3 to 4 days.

2. Food intake per day=

$$2. Food intake per day = \frac{( Starting weight of filled food cup - End weight of food cup )}{number of days}$$

3. Weight gained per day=

$$3. Weight gained per day = \frac{( End weight of rats - Starting weight of rats )}{numbers of days}$$

4. Protein intake per day=Food intake per day×Protein amount in the diet (%)

5. Protein efficiency=

$$5. Protein efficiency = \frac{Weight gained per day}{protein intake per day}$$

6. Protein Efficiency Ratio=

$$6. Protein Efficiency Ratio = \frac{\begin{matrix}Weight gained per day for test diet / \\ protein intake per day for test diet \times 100\end{matrix}}{\begin{matrix}Weight gained per day for control diet / \\ protein intake per day for control diet\end{matrix}}$$

7. Student's t-test was used to compare the results for statistical significance. p value<0.005 was considered significant.

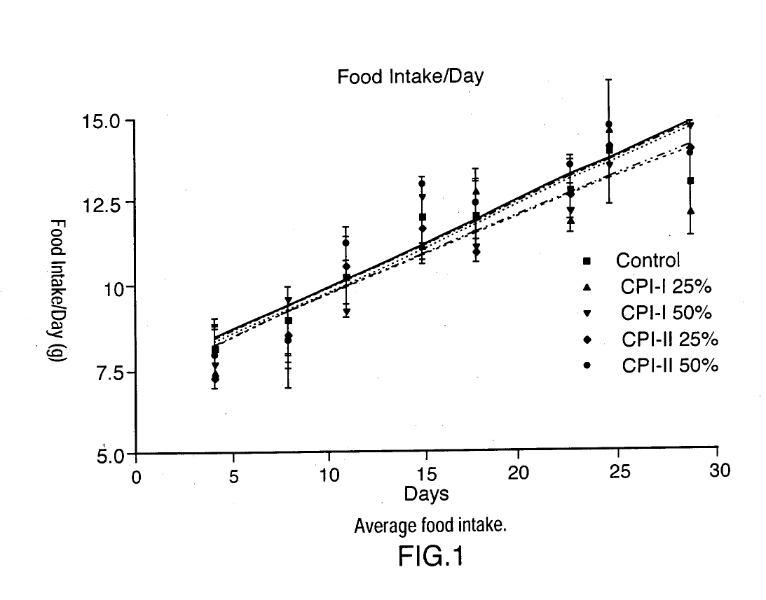

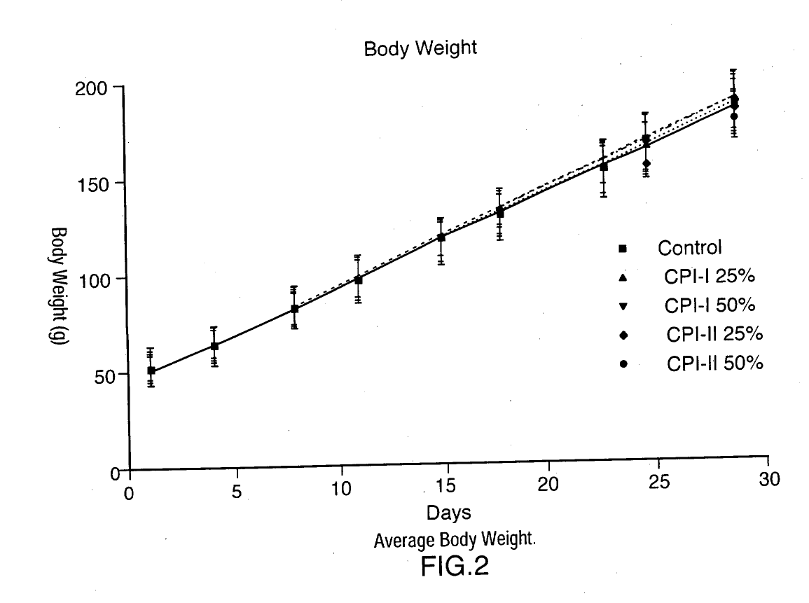

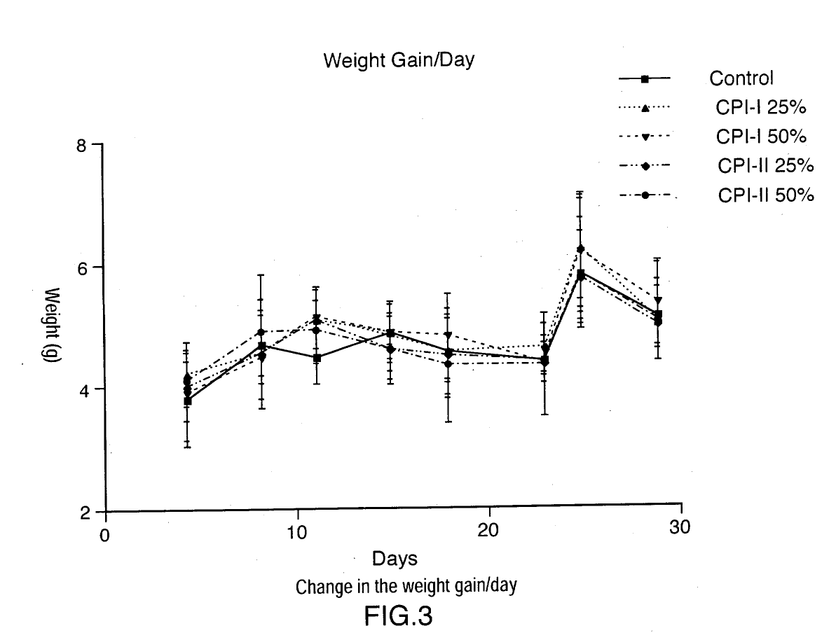

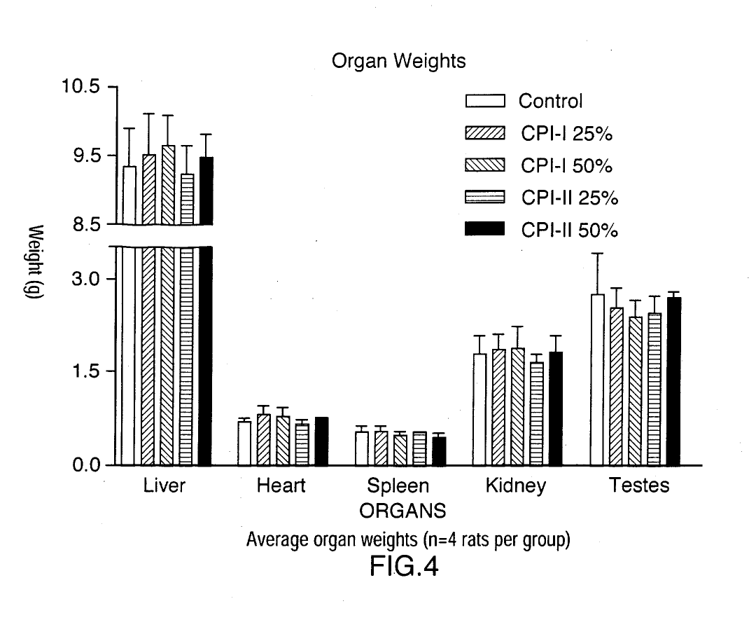

The rats consumed 8 to 14 g of food per day and there were no major differences in the average food consumption by any group during the study period (FIG. 1). FIG. 2 shows the growth in the body weight of rats. There were again no differences in the growth pattern of these animals, moreover the rate of increase in the body weight were also identical in all the groups (FIG. 3). At the end of 28 days on different diets, four representative animals from each group were sacrificed and the major organs were collected and weighed. The average weights of all the major organs were identical in all the groups (FIG. 4).

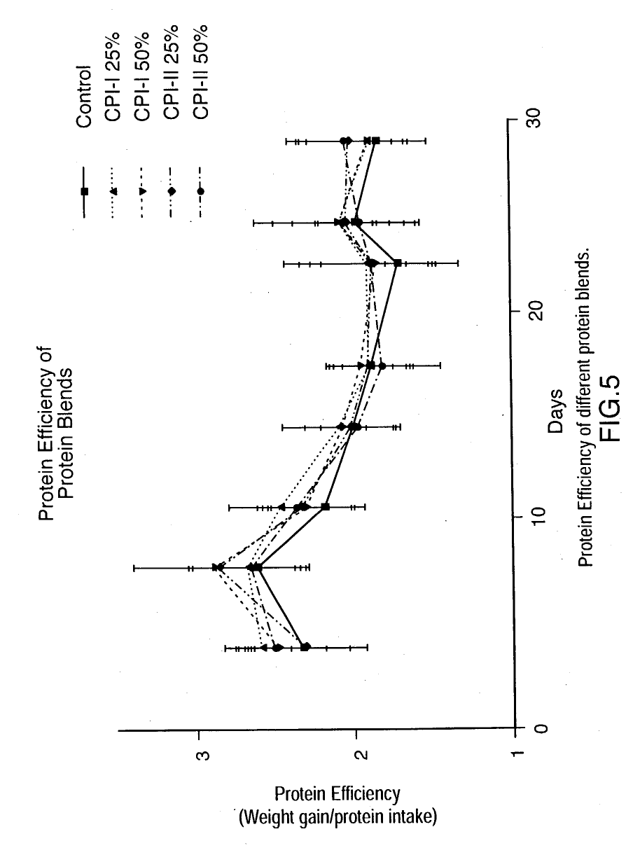

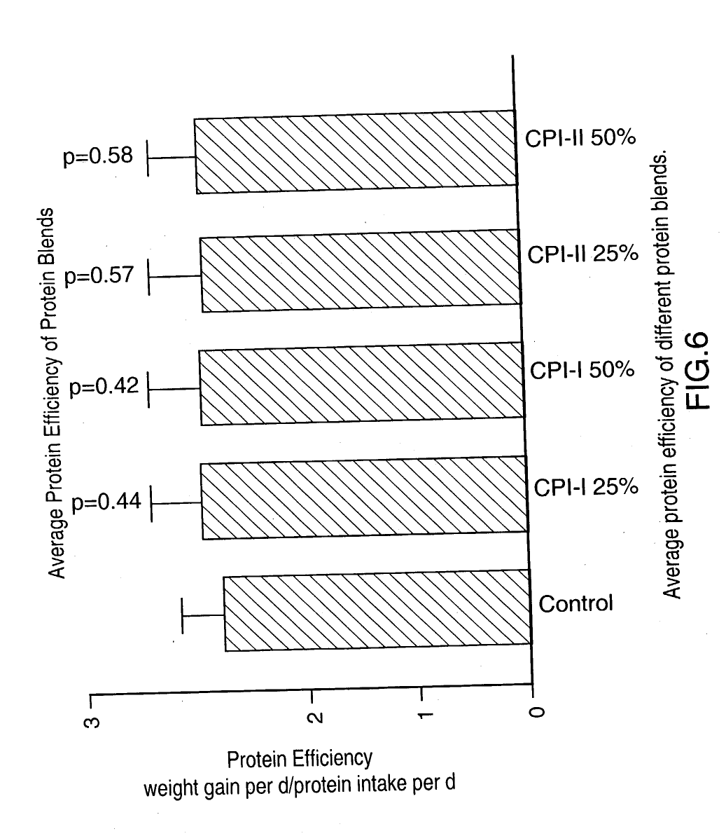

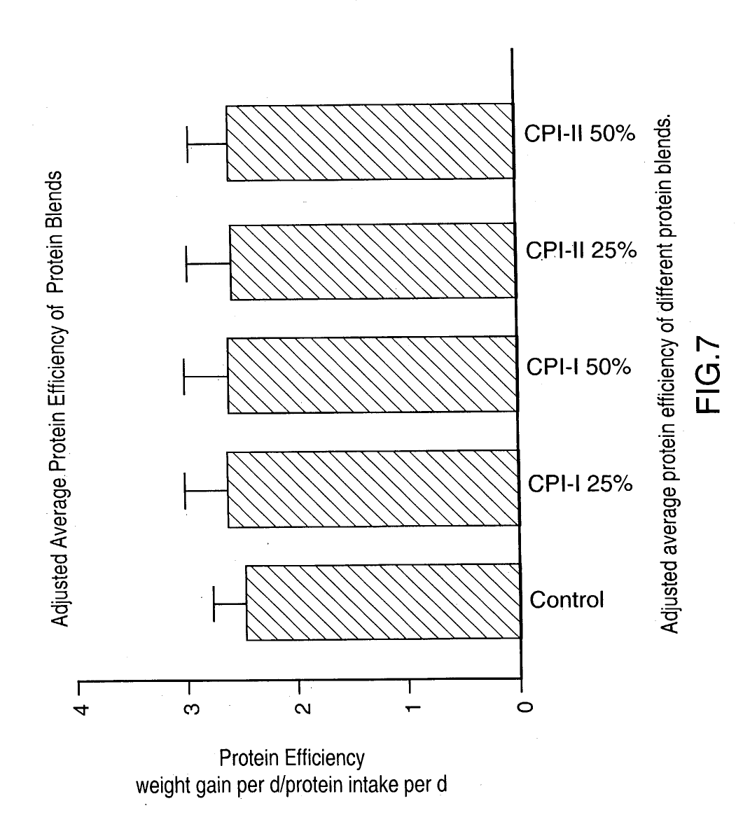

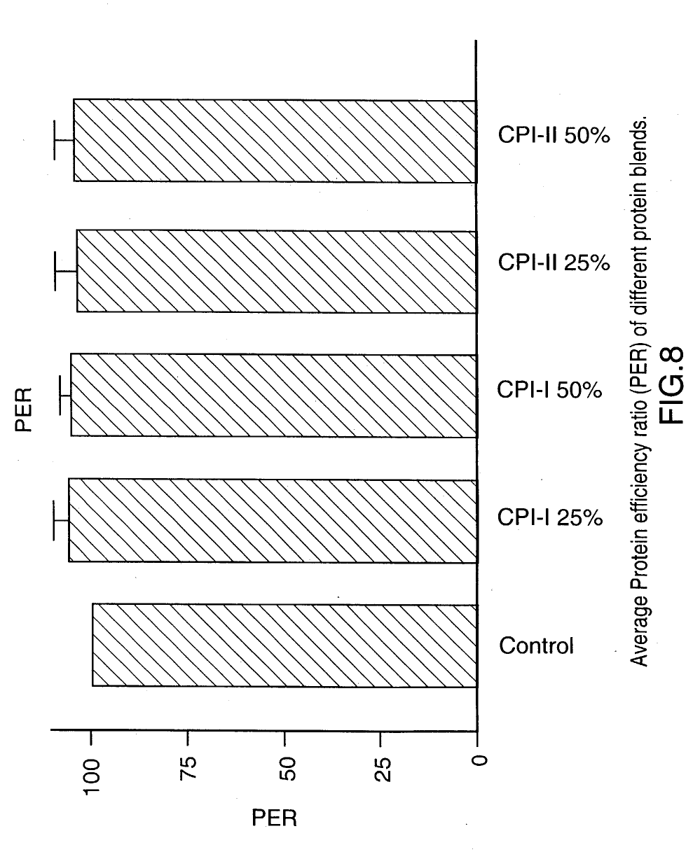

FIG. 5 shows the plot of protein efficiency (Weight gained per day/protein intake per day) with protein blends. Again, there were no major differences. In addition, the average protein efficiency on each protein blend was identical (FIG. 6). Average protein efficiency for the standard casein diet (control) was adjusted to 2.5 and the average protein efficiencies of different protein blends were calculated (FIG. 7). Protein efficiency ratio (Protein Efficiency of control diet×100/Protein Efficiency of experimental diet) is shown in FIG. 8. Although these PER values are not statistically different, it is interesting to note that in all cases the protein CPI trend higher than the control and had no adverse effects on the growth of the animals.

From the results obtained in this study, it can be concluded that the CPI diets (CPI-I and CPI-II) at 25% and 50% levels had no adverse effects on the food intake, body weight gain, growth, major organ weights of the animals and Protein Efficiency Ratio.

### SUMMARY OF DISCLOSURE

In summary of this disclosure, the present invention provides a novel animal food composition in which a canola protein isolate is used as a substitution for proteinaceous material conventionally employed therein. Modifications are possible within the scope of this invention.

TABLE I
(AIN-93G)
ANALYSIS

| | |
|---|---|
| Protein | 18.7% |
| Fat | 7.0% |
| Fiber | 5.0% |
| Carbohydrate | 64.7% |
| Digestible Energy · kcal/gm | 3.97 |

INGREDIENTS

| | g/kb diet |
|---|---|
| Cornstarch | 397.486 |
| CaseIn (≧85% protein) | 200.000 |
| Dextrinized cornstarch (90-94% tetrasaccharides) | 132.000 |
| Sucrose | 100.000 |
| Soybean Oil (no additives) | 70.000 |
| Fiber | 50.000 |
| Mineral mix (AIN-93G-MX) | 35.000 |
| Vitamin mix AIN-93-VM) | 10.000 |
| L-Cyscine | 3.000 |
| Choline bitartrate (41.1% choline) | 2.500 |
| Tert-butylhydroquinone | 0.014 |

| AIN-93G-MX Mineral Mix | g/kb diet |
|---|---|
| Calcium carbonate, anhydrous, 40.04% Ca | 357.00 |
| Potassium phosphate, monobasic 22.76% P;: 28.73% K | 196.00 |
| Potassium citrate tri potassium, monohydrate, 36.16% K | 70.78 |
| Sodium chloride, 39.34% Na; 60.66% Cl | 74.00 |
| Potassium sulfate, 44.87% K; 18.39% S | 46.00 |
| Magnesium oxide, 60.32% Mg | 24.00 |
| Ferric citrate 16.5% Fe | 6.06 |
| Zinc carbonate, 52.14% Zn | 1.65 |
| Manganous carbonate, 47.79% Mn | 0.63 |
| Cupric carbonate 57.4% Cu | 0.30 |
| Potassium iodate, 59.3% I | 0.01 |
| Sodium selenite, anhydrous, 41.79% Se | 0.01025 |
| Ammonium paramolybdate, 4 hydrate, 54.34% Mo | 0.00795 |

| Potentially Beneficial Mineral Element | |
|---|---|
| Sodium meta-silicate, 9 hydrate, 9.88% Sc | 1.45 |
| Chromium potassium sulfate, 12 hydrate, 10.42% Cr | 0.275 |
| Lithium chloride, 16.38% Li | 0.0174 |
| Boric acid, 17.5% B | 0.0815 |
| Sodium fluoride, 45.24% F | 0.0635 |
| Nickel carbonate, 45% Ni | 0.0318 |
| Ammonium vanadate, 43.55% V | 0.0066 |
| Powdered sucrose | 221.026 |

| AIN-93VX Vitamin Mix | g/kb diet |
|---|---|
| Nicotinic acid | 3.000 |
| Ca pantothenate | 1.600 |
| Pyridoxine-HCL | 0.700 |
| Thiamin-HCL | 0.600 |
| Riboflavin | 0.600 |
| Folic acid | 0.200 |
| D-Biotin | 0.020 |
| Vitamin B-12 (cyanoccoalamin) (0.1% in mannitol) | 2.500 |
| Vitamin E (all-zac-α-tocopheryl acetate) (500 IU/g) | 15.000 |
| Vitamin A (all-trans-retinyl palmitrate (500,000 IU/g) | 0.800 |
| Vitamin D3 (cholecalciferol) (400,000 IU/g) | 0.250 |
| Vitamin K (phylloquinone) | 0.075 |
| Powder sucrose | 974.655 |

What we claim is:

1. In an animal feed composition comprising at least one proteinaceous material, the improvement which comprises at least partially replacing the at least one proteineaceous material with at least one canola protein isolate having a protein content of at least about 90 wt % as determined by Kjeldahl nitrogen×6.25 (N×6.25) on a dry weight basis.

2. The composition of claim 1 wherein the at least one canola protein isolate has a protein content of at least about 100 wt % (N×6.25).

3. The composition of claim 1 formulated for domestic pets.
